(19) United States
(12) Patent Application Publication
(10) Pub. No.: US 2003/0039211 A1
(43) Pub. Date: Feb. 27, 2003

(54) Distributed bandwidth allocation architecture

(76) Inventors: Harry S. Hvostov, San Jose, CA (US); Rehan Shamsi, San Jose, CA (US)

Correspondence Address: Sawyer Law Group, 2465 E. Bayshore Road, Suite 406, Palo Alto, CA, 94303, US

(21) Appl. No.: 09/938,373

(22) Filed: Aug. 23, 2001

(51) Int. Cl. H04L 12/407

(52) U.S. Cl. 370/230; 370/447; 370/461

(57) ABSTRACT

A communications system uses a distributed architecture for allocating bandwidth to end units. In one embodiment, a Media Access Controller (MAC) processes packets received by a shared I/O port of a node. A fiber optic cable or other type of cable connects the I/O port to a plurality of end units, such as optical network units (ONUs). The ONUs request bandwidth allocations from the node and then wait to be granted access to the cable prior to transmitting their data. A Bandwidth Allocation Strategy (BAS) server (e.g., a CPU) in the node communicates with the various MACs and determines the bandwidth allocated to each ONU in response to requests by the ONUs for bandwidth. The BAS server accesses one or more algorithm processors for calculating the required access time (for a TDMA system) for each ONU allocation request.

### FIELD OF THE INVENTION

This invention relates to communications systems and, in particular, to an automatic bandwidth allocation scheme.

### BACKGROUND

In one type of communications network, a node has a number of input/output (I/O) ports, each port being connected to a fiber optic cable or copper cable. Each cable may carry data for a plurality of different end units, and the cable typically branches out to each end unit. In an optical network, the end units are sometimes referred to as optical network units (ONUs).

Typically, the ONUs connected to a shared I/O port of the node dynamically request bandwidth allocations for transmission on the shared cable. The node must then evaluate all the requests for bandwidth on the shared cable and allocate the bandwidth fairly amongst the ONUs. The allocations (e.g., transmission times in a TDMA system) are then transmitted back to the ONUs. Such bandwidth allocation processing by the node uses up considerable overhead, delays the various transmissions of the ONUs while the allocations are being scheduled, and fails to maximize the bandwidth usage of the system.

Further, the typical bandwidth schedulers are not easily scalable. For example, connecting more ONUs to the node requires more bandwidth allocation processing. The bandwidth allocation processing is frequently performed by Media Access Controllers (MACs), controlling access to the I/O ports. Such additional processing may overload the processing power of the MACs, requiring more robust MACs. It would be desirable to not have to replace the MACs.

What is needed is a new type of architecture for allocating bandwidth amongst end units that does not suffer from the above-described drawbacks.

### SUMMARY

A communications system is disclosed herein that uses a distributed architecture for allocating bandwidth to end units. In one embodiment, a Media Access Controller (MAC) processes packets received by a shared I/O port of a node. A fiber optic cable or other type of cable connects the I/O port to a plurality of end units, such as optical network units (ONUs). The ONUs request bandwidth allocations from the node and then wait to be granted access to the cable prior to transmitting their data. In one embodiment, there are a plurality of I/O ports, each having an associated MAC.

A Bandwidth Allocation Strategy (BAS) server (e.g., a CPU) in the node communicates with the various MACs and determines the bandwidth allocated to each ONU in response to requests by the ONUs for bandwidth. The BAS server is a “server” in the sense that it provides resources that are shared by a plurality of MACs (or other types of I/O controllers). The BAS server accesses one or more algorithm processors for calculating the required access time (for a TDMA system) for each ONU allocation request.

The BAS server accesses a recent bandwidth allocation history file for the various ONUs to ensure that the average bandwidth allocated to any particular ONU is fair. Another memory file accessed by the BAS server contains traffic flow parameters for each of the ONUs.

The BAS server, in conjunction with the algorithm processors, determines the proper allocation of bandwidth for each ONU based on the ONUs' requests and the information in the history and parameter sets files. The BAS server then transmits the allocation information to the appropriate MAC(s). Each MAC then builds a message packet and transmits the bandwidth allocations to the various ONUs associated with the MAC.

In this manner, the MACs are freed up to perform other tasks, thus speeding up the network. Further, the system is easily scalable by adding more algorithm processors to calculate the appropriate transmission allocations (e.g., time intervals) for the ONUs. Other embodiments of the invention are also described.

### BRIEF DESCRIPTION OF THE DRAWINGS

FIG. 1 is a block diagram illustrating the pertinent functional units of a communications network in accordance with one embodiment of the invention.

FIG. 2 is a flow chart identifying various steps for allocating bandwidths to various end units.

FIG. 3 is the allocation map message format transmitted by the MACs to the ONUs conveying the map information created by the BAS server.

FIG. 4 is a timeline illustrating examples of bandwidth allocation for voice and other data for the various ONUs connected to a shared I/O port.

### DETAILED DESCRIPTION OF THE EMBODIMENTS

FIG. 1 illustrates a communications network employing the present invention. The system may use an Ethernet protocol for functions not specifically described herein. Since the present invention is related to bandwidth allocation, features and functions of a communications network not related to the invention may be conventional and need not be described.

In FIG. 1, a communications network 10 includes a node 12, which may include a routing function to route data from one port to another port of the node. Such a routing function and its implementation may be conventional. The node 12 is connected to a plurality of end units, in this case optical network units (ONUs) 14. Each ONU 14 may serve a particular subscriber and may handle voice traffic and any other type of data. In the embodiment described, it will be assumed that the ONUs are connected to node 12 via fiber optic cables 16. A single fiber optic cable 16 is shared amongst a plurality of ONUs 14, and the shared cable is coupled to an I/O port 18 of node 12. An optical splitter may be used to branch off the shared cable 16 to the various ONUs. Other intermediary components may be included between the I/O port 18 and the ONUs 14.

A media access controller, such as MAC 1, MAC 2, or MAC n, communicates with an associated I/O port 18. One function of the MACs is to build packets for transmission and parse packets upon receipt. MACs are well known and commercially available. In one embodiment, block 22 between each of the MACs and their respective I/O ports 18 includes an 8 bit/10 bit encoder, a serializer/deserializer (SERDES), and an optical transceiver. Such components are well known and need not be described.

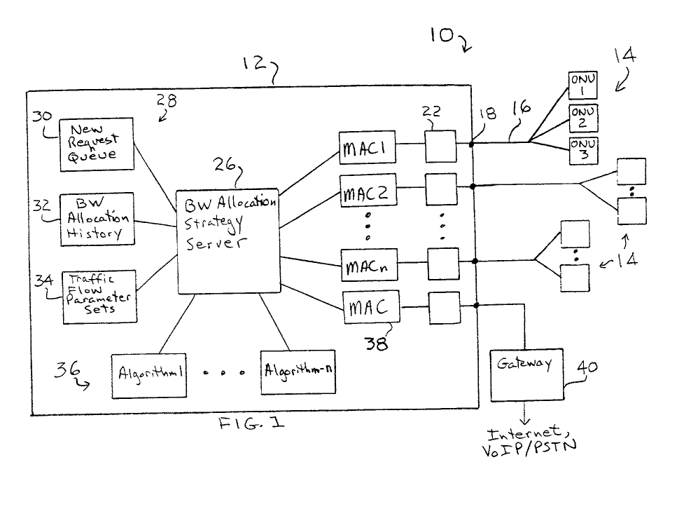

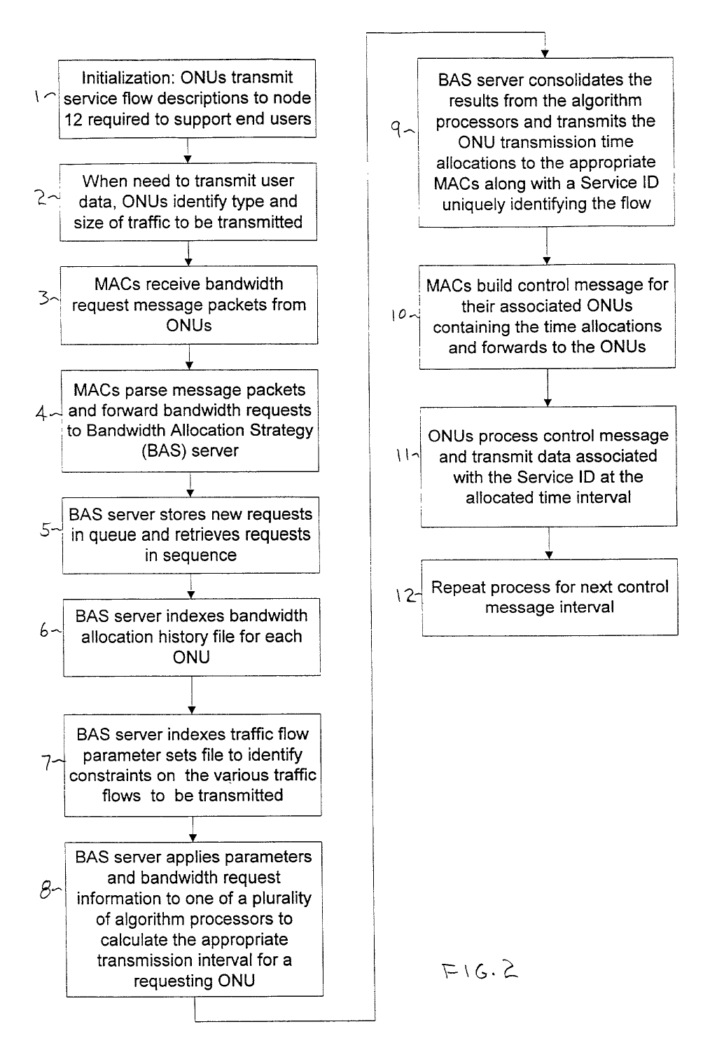

Each of the MACs communicates with a Bandwidth Allocation Strategy (BAS) server 26. The BAS server 26 may be executing on any suitable CPU, such as a Power PC™ by Motorola running on a VX Works™ operating system. An introduction to the various functional units is presented below, followed by a more detailed discussion with respect to the flowchart of FIG. 2.

The BAS server 26 accesses various memory files 28 as follows. A new request queue 30 temporarily stores the bandwidth allocation requests from the various ONUs, and the BAS server 26 operates on each request in turn. A bandwidth allocation history file 32 stores recent bandwidth allocations for the various ONUs so the server 26 can determine if the average bandwidths allocated for the various ONUs are fair and in accordance with any service level agreements between the subscribers and the service provider. A traffic flow parameter sets file 34 provides rules or constraints on traffic flow, such as identifying rules for each class of traffic to be transmitted by a particular ONU.

Algorithm processors 36 are used by server 26 to determine, on a per traffic flow or ONU basis, the bandwidth allocations for the ONUs based on the type and amount of traffic to be transmitted, the bandwidth allocation history, and the traffic flow parameter sets. Additional algorithm processors may be added to provide more processing power as ONUs are added to the network. Additional algorithm processors that perform bandwidth allocation for specific traffic flows may also be added. An example is an algorithm for bandwidth allocation for packet voice traffic with stringent packet delay and interpacket jitter requirements.

The node 12 may route data transmitted by an ONU to another ONU connected to the node 12 or may route transmissions from an ONU 14 to a MAC, such as MAC 38, connected to an Internet gateway or a Voice Over IP (VoIP)/PSTN gateway 40.

The actual circuitry used to implement node 12 may be conventional, and the functions of the various blocks may be carried out using a combination of software, hardware, and firmware. In one embodiment, the node 10 processes data at a rate exceeding 1 gigabits per second.

FIG. 2 is a flow chart illustrating steps for allocating bandwidth requested by the ONUs 14.

In step 1 of FIG. 2, an ONU added to the network performs an initialization routine. The ONU transmits a service flow description specifying the link resources required to support each user of the ONU. This may be done when the ONU is initially connected to the network to identify the services which the various subscribers connected to the ONU have contracted for with the service provider. Each service flow description is identified by a unique reference and is associated with a set of parameters (stored in the traffic flow parameter sets file 34) required by the network to allocate and prioritize appropriate resources to support the service flow. Such a service flow description may consist of several parameters whose values identify such Quality of Service (QoS) requirements as traffic priority and scheduling algorithm, minimum and maximum traffic rates, bound on interpacket jitter and delay, and maximum burst size. Such service flow descriptions can be embedded inside an ONU configuration file and activated either during the registration process or periodically on demand. Such information is then stored in the traffic flow parameter sets file 34 for each ONU and is subsequently used by the BAS server 26 when the ONU requests bandwidth for the transmission of data.

Service IDs are assigned by node 12 to the various ONUs once the ONUs have registered. Service IDs may include one Service ID unique to that ONU for each class of service that the ONU has requested. The traffic flows are then uniquely identified by a Service ID by both the ONU and node 12. All bandwidth grants are made by node 12 for each Service ID in accordance with the QoS requirements contained in the service flow description.

In step 2, an ONU has the need to transmit voice or other data to node 12 and transmits a request for bandwidth allocation by identifying the type of traffic to be transmitted (e.g., by service ID) and the size of the data file to be transmitted. The allocation request intervals can be made open to all of the ONUs simultaneously, some ONUs, or a specific ONU. If multiple ONUs transmit a request for bandwidth at the same time and there is a collision, a conventional collision management protocol takes place, requiring the pertinent ONUs to re-transmit their requests at randomly delayed times. Alternatively, the node 12 can poll the various ONUs for their bandwidth requests.

In step 3, the associated MAC receives the bandwidth request from a requesting ONU identifying the type/class of data identified by the Service ID and quantity of data to be transmitted.

In step 4, the MAC parses the packet and forwards the bandwidth allocation request to the BAS server 26.

In step 5, the BAS server 26 stores each new request for bandwidth allocation in the new request queue 30 and processes the requests in turn.

In steps 6 and 7, the BAS server 26 acts on the next request in the queue 30 and indexes values in the bandwidth allocation history file 32 and in the traffic flow parameter sets file 34 for the particular ONU requesting the bandwidth, based on the Service ID.

The traffic flow parameter sets file 34 identifies the QoS constraints on bandwidth allocation for the particular ONU, so as to provide only those services that the particular subscriber has contracted for with the service provider, such as priority, traffic rates, and burst size. Examples of different priorities (or classes of service) include voice traffic (no delays), committed data rates, and best effort. The bandwidth allocation history file 32 identifies the various ONUs' recent allocations to allow server 26 to determine if an ONU will exceed its guaranteed average bandwidth allocation for which the subscriber has contracted. This affects an ONU's access to the link whereby, if the ONU has already exceeded its average bandwidth allocation, it may receive lower priority access to the link for its next burst. Accordingly, the BAS server 26 now has sufficient information to allocate link access to the requesting ONU.

In step 8, the BAS server 26 identifies a particular algorithm processor 36 to calculate a time interval (for a TDMA implementation) necessary for the ONU to transmit its data while meeting the constraints imposed by the bandwidth allocation history file 32 and the traffic flow parameter sets file 34. The various algorithm processors 36 may operate in parallel to simultaneously calculate time intervals for a plurality of ONUs.

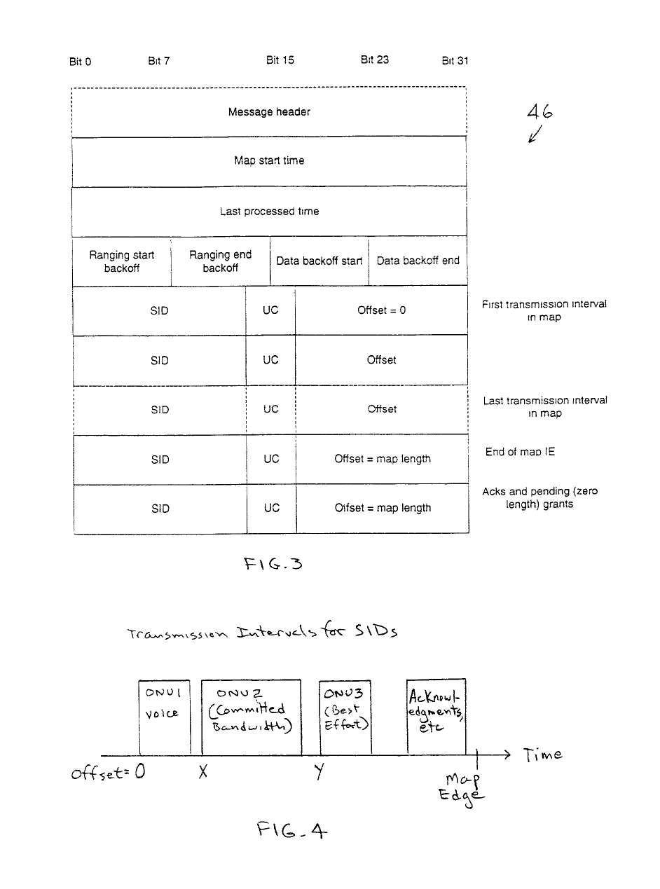

In one embodiment of the TDMA network, access to the shared links is broken up into transmission intervals consisting of a variable number of fixed duration time slots. Clock signals generated by node 12 (the master) are transmitted to each of the ONUs to update their internal time clocks, and bandwidth allocations to the shared links are identified by absolute times in conjunction with offsets from the absolute times, to be described in more detail with respect to FIG. 3. The algorithm processors 36 selected by the BAS server 26 identify the time slot intervals necessary to accommodate the data to be transmitted by the ONUs. For example, if voice is to be transmitted by an ONU, the algorithm processor will typically guarantee periodic slot times necessary to carry the voice signal without any audible delay. If the class of traffic is the best effort class, the algorithm processor may only provide whatever time interval is remaining between allocation request intervals after higher priority traffic has been assigned slot times. The server will then provide the best effort allocation as the last allocation in the allocation map message, described with respect to FIG. 3.

In one embodiment, certain algorithm processors 36 are dedicated to certain types of bandwidth calculations, such as for voice traffic. This speeds up processing time since the algorithm processor is already programmed to carry out a specific calculation based on the bandwidth allocation request. The algorithm processors may be programmed using firmware to further speed up processing.

In another embodiment, different algorithm processors 36 perform different functions in the calculation of a single transmission interval.

One skilled in the art can easily design code or firmware to calculate the required time interval for transmitting certain data, subject to the various flow constraints.

In step 9, the BAS server 26 consolidates the calculated time intervals from the algorithm processors 36 and generates data for a message format map 46, shown in FIG. 3.

In step 10, the appropriate MAC builds the message map 46 from the data provided by server 26 and transmits the map 46 to the ONUs. In other embodiments, the allocation message may be transmitted by node 12 to either a selected ONU or any number of ONUs. The message map 46 shown in FIG. 3 informs the ONUs of the time interval in which they may transmit their data. The map message fields are defined as follows.

Map Start Time is the absolute time that the map allocation becomes effective.

Last Processed Time is the latest absolute processing time of an allocation request. This is the end of the processing time for the information in the current map so that allocations processed before this latest absolute time should have showed up in a map or else there was contention between multiple ONU requests. Since, in one embodiment, the ONUs cannot detect collision directly, they wait for a subsequent map message from the node 12. A collision has occurred if the next map contains a Last Processed Time value more recent than the ONU request transmission, but does not contain either a transmission grant or a data acknowledge. For this embodiment, the ONUs must record each contention mode based transmission time for comparison against the Last Processed Time value in the map messages.

Ranging Start Backoff is the initial ranging backoff start window in the event there is a collision, and Ranging End Backoff is the initial ranging backoff end window. “Ranging” refers to the ONUs performing a ranging routine by transmitting signals and receiving their acknowledgment to detect a propagation delay between the master clock in the node 12 and the ONU clock. This delay is then used by the ONU to determine a timing offset from the master clock in node 12. If there is contention between ONUs for this ranging transmission, the ONUs will delay the transmission for a random time within the ranging window. If there is again contention, the ranging window time is expanded by a factor of 2 to reduce the probability of collisions, but not exceeding the Ranging End Backoff window time.

Data Start Backoff is a value identifying the starting request/data transmission backoff window in the event of a collision, and the Data End Backoff value is the ending request/data transmission backoff window. This is used only if there is contention in the transmissions of two or more ONUs. The ONUs delay the re-transmitting for a random period within the window to avoid further collisions. If there is again a collision, the window for the random delay is increased by a factor of 2 but not exceeding the end backoff window interval.

The Service ID (SID) is a unique value identifying the particular traffic flow from an ONU for which the bandwidth allocation was requested. A SID usually identifies a particular class of data from a particular ONU and is established when the ONU gets connected to the network. A SID may specify a single ONU or may specify multiple ONUs, where the multiple ONUs may attempt to transmit data in the allocated time period subject to any contentions that may arise.

The Usage Code (UC) identifies the general type of data to be transmitted in the allocated time. One usage code value identifies that the interval is for allowing the ONUs to make transmission requests. Another usage code value identifies to the ONUs that the allocated interval is for the transmission of data in response to a bandwidth request message from a specific ONU. Other examples are provided in the table below.

The Offset value (starting from 0 time) identifies the time interval, starting from the Map Start Time, for the specified ONU to transmit its data on the shared link. The offsets can be in terms of byte intervals, clock cycles, or a number of fixed slot times, depending on the chosen implementation. In one embodiment, the offsets are in 10 msec intervals.

A summary of the Usage Codes is provided in the below table along with the permissible SID types and the significance of the Offset value for the particular Usage Code.

| Information | Usage | | |
|---|---|---|---|
| element name | Code | SID type | Offset |
| Request | 1 | Any | Start of request transmission |
| | | | interval |
| Request/data | 2 | Broadcast/ | Start of request/data transmission |
| | | multicast | interval |
| Initial | 3 | Broadcast | Start of initial ranging transmission |
| maintenance | | | interval |
| Regular | 4 | Unicast | Start of continued ranging interval |
| maintenance | | | for specific ONU |
| Data grant | 5 | Unicast | Start of data grant for specific |
| | | | ONU (compared length = 0 |
| | | | denotes pending grant) |
| Null | 6 | Zero | Ending offset of preceding interval. |
| | | | Bounds the length of the last |
| | | | allocation. |
| Data ack | 7 | Unicast | Set of map length |
| Reserved | 8-TBD | Any | Reserved |

The format of each information element (IE) consists of a SID field, UC field, and timing offset field in suitable time units.

The Request IE indicates an interval during which upstream transmission requests can be made. If the IE includes the broadcast SID, it is addressed to all ONUs and denotes a contention based transmission request interval. If the IE is addressed to a specific SID, it serves as a invitation to the specific ONU to make a transmission request in support of a service flow with specific QoS guarantees. Since the bandwidth request message length is fixed, the length of the request IE is also fixed to allow a single request transmission.

The Request Data IE is an indication to the ONUs that both bandwidth requests and data transmissions in contention mode are allowed during the interval. Since data transmissions can result in collisions, the node 12 will provide a data acknowledgement in the following map message. The data acknowledgement is requested by the ONU using an extended header.

The Initial Maintenance IE indicates a long interval, equal to the worst case round trip propagation delay plus the transmission overhead of the ranging request. The interval is used by ONUs initially joining the network and performing initial ranging.

The Regular Maintenance IE indicates a unicast interval used for regular re-ranging by ONUs at the request of the node 12.

The Data Grant IE is issued by the node 12 in response to a bandwidth request message from a specific ONU. A grant interval length of 0 indicates a pending request acknowledgement implying an actual transmission opportunity in a later map message.

The Data Acknowledgement IE serves as a confirmation that the node 12 has successfully received a data protocol data unit (PDU) (i.e., a packet) from the ONU requesting a data acknowledgement. This is usually done for data PDUs transmitted in contention mode during a Request Data interval.

The Null IE indicates the length of the last allocated interval in the map. All zero length information elements such as zero length grants and data acknowledgements must follow the Null IE in the map. This is necessary to ensure that all elements requiring actual upstream transmission from the ONU are processed first to meet the real time transmission requirements imposed by the map allocation.

In step 11 of FIG. 2, all the ONUs connected to an associated MAC receive the allocation map message. The message is then parsed by the various ONUs and processed to determine which transmission allocations pertain to which ONU and to which data flow. The ONUs then transmit data in accordance with the allocations.

In step 12, the allocation process is repeated during a next map message interval.

FIG. 4 is a time line showing an example of time allocations for various ONUs to use a shared link connected to a particular I/O port 18 in FIG. 1. In the example of FIG. 4, a particular SID identifies a voice class flow from ONU 1, and this slot time would likely be repeated at constant intervals to ensure no interruption in the voice traffic. A request by ONU 2 for a non-voice data transmission of 10MBs is allocated a single interval. A request by ONU 3 for an allocation for a best effort transmission has been allocated an available interval only after the bandwidth for higher priority traffic has been allocated. There may be other allocations granted during a map message interval.

The map message is broadcast downstream to all ONUs ahead of its effective map start time to account for various sources of delay in the network, including worst case round trip propagation delay from the ONU farthest from the node 12, the node 12 queuing delay, and the map processing delay.

In one embodiment, a single map message may contain 240 information elements, and several maps can be outstanding at any one time. In one embodiment, a maximum of 4096 transmission slots may be allocated to a single transmission, although the average transmission interval size is estimated to be about 273 bytes. Given a transmission slot size of 16 bytes, the maximum map allocation is for a transmission of 65,536 bytes.

The trade off in map size is between downstream (toward the ONUs) bandwidth conservation and upstream transmission latency. Short allocation maps tend to be wasteful of the downstream channel bandwidth but help minimize upstream transmission latency. Conversely, long allocation maps impose lower downstream bandwidth overhead but lead to larger packet transmission delays and longer queues.

The distributed bandwidth allocation architecture shown in FIG. 1 eliminates the overhead in each of the MACs for allocating bandwidth. This allows the MACs to have a higher throughput, thus maximizing the network resources. Additionally, as additional ONUs are connected to a shared cable 16, the MACs do not become overloaded with additional bandwidth allocation tasks since this is done by the BAS server 26 and the algorithm processors 36. Thus, more ONUs can be supported. As additional I/O ports 18 are added and additional ONUs 14 are added, the BAS server 26 can be scaled by increasing the size of the memory files and adding algorithm processors (e.g., FPGAs) to carry out processing in parallel to generate the offset intervals for the ONU requests.

The hardware used to implement this system may be conventional. The software and firmware used to implement the novel functions of this invention would be well within the skills of those of ordinary skill in the art in the field of communications networks. Many types of protocols, including Ethernet, may be employed using this distributed bandwidth allocation technique.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A communications device comprising:
a plurality of media access controllers (MACs) communicating with associated input/output ports, said ports receiving bandwidth allocation requests from one or more end units sharing an associated I/O port; and
a server communicating with said MACs for receiving requests for bandwidth allocation from a plurality of said end units and identifying transmission intervals in response to said requests for bandwidth allocation, wherein said intervals are communicated to said end units.

2. The system of claim 1 further comprising algorithm processors accessed by said server to perform bandwidth allocation calculations and identify a bandwidth allocation to said server based on certain factors.

3. The system of claim 2 wherein said certain factors include a bandwidth allocation history associated with an end unit requesting bandwidth.

4. The system of claim 2 wherein said certain factors include class of service.

5. The system of claim 2 wherein ones of said algorithm processors are dedicated to performing bandwidth allocation calculations for only specific types of traffic flows.

6. The system of claim 2 wherein one or more of said algorithm processors perform a portion of said bandwidth allocation calculations, and certain other ones of said algorithm processors complete said calculations.

7. The system of claim 1 wherein said server identifies said transmission intervals for a plurality of said end units based on a bandwidth allocation history associated with an end unit requesting bandwidth.

8. The system of claim 1 wherein said server accesses a file identifying support services to be provided by said communications device for individual ones of said end units and calculates said transmission intervals for a plurality of said end users based on said support services.

9. The system of claim 8 wherein said support services comprise a class of service to be supported by said communications device.

10. The system of claim 8 wherein said support services comprise a data rate to be supported by said communications device.

11. The system of claim 8 wherein said support services include a burst size to be supported by said communications device.

12. The system of claim 1 further comprising optical fibers coupled to said input/output ports for transmitting optical signals to and from said communications device.

13. The system of claim 1 wherein said MACs build a message packet for transmission to one or more of said end units, said message packet including said transmission intervals determined by said server for one or more of said end units.

14. The system of claim 13 wherein said message packet comprises:
a message header;
a message map start time field identifying to said end units a start time for transmission intervals conveyed in said message packet;
a last process time field identifying a time at which said server ceased processing bandwidth allocation requests for the message packet; and
one or more identification fields identifying a traffic flow from one or more of said end units and a corresponding offset time from said map start time to identify transmission intervals for respective ones of said end units.

15. The system of claim 1 wherein said communications device is part of a time division multiple access (TDMA) network and wherein said transmission intervals identify transmission times referenced to a master clock time.

16. The system of claim 15 wherein said transmission intervals correspond to an integral number of fixed slot times.

17. The system of claim 1 wherein said transmission intervals are identified by an offset from an absolute time.

18. The system of claim 1 wherein said server accesses a bandwidth allocation history file to identify bandwidths previously allocated to various end units, said bandwidth allocation history file being used to determine said transmission intervals for said end units.

19. A method performed by a communications device for allocating bandwidth comprising:
receiving packets containing transmission bandwidth requests from a plurality of end units;
parsing said packets from said end units by a plurality media access controllers (MACs), each MAC being associated with one or more end units;
forwarding said bandwidth requests to a first queue;
retrieving said bandwidth requests from said first queue by a server being shared by said MACs;
calculating by said server appropriate transmission intervals for said end units in response to said bandwidth requests;
transmitting said transmission intervals to respective ones of said MACs by said server;
building a message packet by respective ones of said MACs incorporating a plurality of transmission intervals calculated by said server; and
transmitting by said respective ones of said MACs said message packet to one or more end units for conveying allocated transmission intervals to said end units.

20. The method of claim 19 wherein said calculating comprises said server accessing one or more algorithm processors for performing calculations for determining said transmission intervals.

21. The method of claim 19 further comprising receiving information from said end units conveying support services to be provided by said communications device, said support services being accessed from a memory when determining appropriate transmission intervals for said end units in response to transmission bandwidth requests by said end units.

22. The method of claim 19 wherein said building a message packet comprises said MACs consolidating various transmission intervals, provided by said server, in a message packet, said message packet comprising:
a message header;
a message map start time field identifying to said end units a start time for transmission intervals conveyed in said message packet;
a last process time field identifying a time at which said server ceased processing bandwidth allocation requests for the message packet; and
one or more identification fields identifying a traffic flow from one or more of said end units and a corresponding offset time from said map start time to identify transmission intervals for respective ones of said end units.

23. The method of claim 19 wherein said calculating comprises said server accessing algorithm processors to perform transmission interval calculations for said end units based on certain factors.

24. The method of claim 23 wherein said algorithm processors perform bandwidth allocations for specific traffic flows.

25. The method of claim 24 wherein said specific traffic flows include voice traffic having certain packet delay and interpacket jitter requirements.

26. The method of claim 23 wherein said certain factors comprise a class of service.

27 The method of claim 23 wherein said certain factors comprise a maximum data rate to be supported by said communications device.

28. The method of claim 23 wherein said certain factors comprise a maximum burst size to be supported by said communications device.
